(19) United States
(12) Patent Application Publication
(10) Pub. No.: US 2012/0259847 A1
(43) Pub. Date: Oct. 11, 2012

(54) Collaborative Data Appliance

(76) Inventor: Ronald S. Gierlack, II, Pittsburgh, PA (US)

(21) Appl. No.: 13/443,931

(22) Filed: Apr. 11, 2012

Related U.S. Application Data
(60) Provisional application No. 61/474,089, filed on Apr. 11, 2011.

(51) Int. Cl. G06F 17/30

(52) U.S. Cl. 707/732; 707/736; 707/737; 707/752; 707/E17.014

(57) ABSTRACT

A modular appliance based architecture is disclosed that allows for database consolidation and systems integration. The collaborative data appliance comprises modules designed to collect and combine data which is relevant to the user, uniquely arranging the data into meaningful views which can be later customized into a multitude of reports. The appliance utilizes a customized data code that allows the appliance to span the disparate databases it will consolidate. The appliance also allows a user to share information across systems in a heterogeneous environment by replicating data between different hardware platforms and data sources, without losing the integrity of the data. Further, the appliance comprises a discovery engine that utilizes Artificial Intelligence (AI), and that requires User Input (UI).

### CROSS-REFERENCE

This application claims priority from Provisional Patent Application Ser. No. 61/474,089 filed Apr. 11, 2011.

### BACKGROUND

Consolidating and integrating database repositories can be a difficult task, requiring major modifications to existing infrastructure and/or software updates, etc. Currently, there is no reliable solution to database consolidation and systems integration. The market consists of, among other things, Enterprise Application Integration (EAI) software applications, which replicate data between different hardware and data sources. However, these software applications have limited functionality and do not allow for customization or flexible integration. Furthermore, implementing new systems is a major undertaking requiring many hours of planning and configuring. Additionally, full data conversions into a new system are riddled with risk, often discouraging users from converting data into the new system.

A new approach to database consolidation and systems integration is needed. The disclosed architecture discloses a modular appliance based model. The collaborative data appliance comprises modules designed to collect and combine data which is relevant to the user, uniquely arranging the data into meaningful views which can be later customized into a multitude of reports. With the collaborative data appliance's modular design, users will be able to quickly adapt to new systems with relatively minimal effort and without having to make major modifications to their existing infrastructure.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

A modular appliance based architecture is disclosed that allows for database consolidation and systems integration. The collaborative data appliance of the present invention comprises at least one internal software module designed to collect and combine data which is relevant to the user from disparate databases, and a discovery engine that formulates queries and uniquely arranges the data into meaningful views which can be later customized into a multitude of reports based on the formulated queries. The collaborative data appliance further comprises a customized data code that allows the collaborative data appliance to span the disparate databases it will consolidate. Typically, the databases would be connected by a proprietary fiber driven backplane. The collaborative data appliance also allows a user to share information across systems in a heterogeneous environment by replicating data between different hardware platforms and data sources, without losing the integrity of the data.

Furthermore in one preferred embodiment, the collaborative data appliance comprises a discovery engine that utilizes Artificial Intelligence (AI), and that requires a User Input (UI). Queries for the discovery engine are dynamically generated from the results of queries down to four levels deep. Typically, the queries are generated from the results of queries down to four levels deep to optimize the performance of the appliance. Once the queries are generated, the queries are keyed in or, entered with the use of any third party software that will work with any web page, i.e., voice recognition. The results of the generated queries can then provide intelligence on each future search. Specifically, the user would rate the results, reporting back to the collaborative data appliance, and that information would then be used for future searches, causing the future searches to become ‘smarter’ or more refined over time.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a collaborative data appliance in accordance with the disclosed architecture.

FIG. 2 illustrates multiple collaborative data appliances disclosing database consolidation and systems integration in accordance with the disclosed architecture.

FIG. 3 illustrates a flowchart disclosing a method for database consolidation and systems integration in accordance with the disclosed architecture.

FIG. 4 illustrates a block diagram of a computing system operable to execute the collaborative data appliance in accordance with the disclosed architecture.

FIG. 5 illustrates an exemplary computing environment operable to provide support for the collaborative data appliance.

### DETAILED DESCRIPTION

The disclosed architecture provides a highly customizable collaborative data appliance which allows for database consolidation and systems integration. The appliance comprises at least one internal software module designed to collect and combine data which is relevant to the user, and a discovery engine that formulates queries and uniquely arranges the data into meaningful views which can be later customized into a multitude of reports. With the appliance's modular design, users will be able to quickly adapt to new systems with relatively minimal effort and without having to make major modifications to their existing infrastructure.

The collaborative data appliance utilizes a customized data code that allows the appliance to span the disparate databases it will consolidate. Further, the appliance comprises a secure modular appliance-based design, which produces easy, customizable in-memory data caching and displays for Enterprise Application Integration (EAI). The collaborative data appliance also allows a user to share information across systems in a heterogeneous environment by replicating data between different hardware platforms and data sources, without losing the integrity of the data.

Further, the appliance comprises a discovery engine that utilizes Artificial Intelligence (AI), and that requires a User Input (UI). Queries for the discovery engine are dynamically generated from the results of queries down to four levels deep, with keyed in or alternatively entered intelligence on each search. The user would rate the results, reporting back to the appliance, and that information would then be used for future searches, causing the future searches to become ‘smarter’ or more refined over time.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

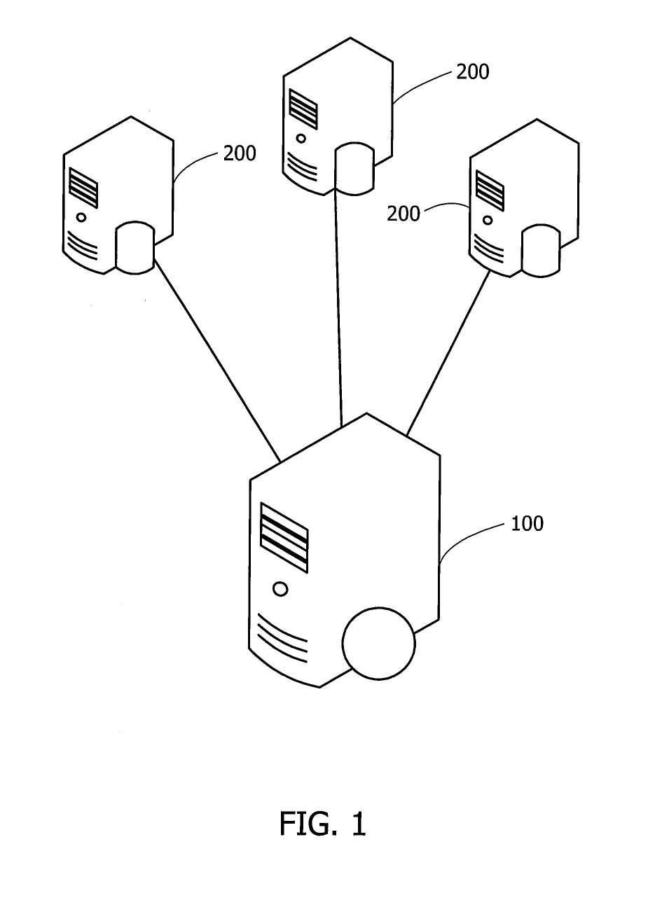

FIG. 1 illustrates a collaborative data appliance 100 in accordance with the disclosed architecture. Specifically in FIG. 1, the collaborative data appliance 100 is securely collecting information from data sources 200 based upon a user's request. The data sources 200 could be located on and/or off-site. For the purposes of this application, we define an appliance as a self-contained software application, that includes the core application logic, operating system that is hardened, data management tools, required databases, web-server, and any other technology as is known in the art, which would enable the software application to be self-managed or self-healing. From an end-users perspective, the collaborative data appliance 100 is a plug-and-play device, that is installed with little upfront Internet Technology (IT) assistance. (i.e., no database administrator is required) and can be fully operational often within minutes. By this definition, we call the collaborative data appliance (the Enossys device) an appliance.

The collaborative data appliance 100 comprises at least one internal software module designed to collect and combine data which is relevant to a user from disparate databases. The data collected can then be rearranged into meaningful views which can be later customized into a plurality of reports. The internal software modules are flexible, meaning that a user can add any number of user systems as is known in the art, such as repositories, databases, sources, etc. upon request. A user can then add customized fields within the administrative interface for complete customization of the data reports. The internal software modules are also clusterable, thereby permitting multiple modules to be assembled together to expand the overall capacity of the collaborative data appliance 100. For example, two collaborative data appliance 100 units can support twice the number of concurrent users as can one collaborative data appliance 100 unit, three collaborative data appliance 100 units can support three times the number of users as can one, etc. Thus, users can be doubled either by adding the same size unit already being used, or by increasing the number of user capacity via configurable settings on the appliance 100.

Furthermore, the internal software modules can expand the number of diverse databases the collaborative data appliance can integrate, (i.e., its capacity). For example, the existing collaborative data appliance might have a limit of seven databases or other user sources. However, more internal software modules can be purchased and added to the existing internal software modules, or a second collaborative data appliance can be added to the first appliance, which would net another seven databases or other user sources. Thus, one collaborative data appliance equals seven, 2=14, 3=21, etc. Users can alternatively buy only internal software modules which would be a user customized add-on to the collaborative data appliance. Users can also mix-and-match the size and selection of collaborative data appliances within a multi-site user organization.

Typically, the internal software modules are a series of bundled database views and data reports. Furthermore, the modules are separate, interchangeable components which can expand the overall capacity of the collaborative data appliance 100. The core views of the bundled databases will be determined through market research, surveys, or any other data gathering tool as is known in the art. The core views of the bundled databases are then customizable to a user's needs. Typically, the users will drive the need for what internal software module is on their collaborative data appliance. For example, one internal software module could comprise unifying accounting and customer relations management systems. More specifically, an internal software module comprising software packages: SOFTRAX® and SugarCRM® would contain the same information as an internal software module comprising Microsoft Dynamics Solomon® and Microsoft Dynamics CRM®. Thus, if a user decides to switch software vendors, all the user needs to do is utilize one of the collaborative data appliance's 100 related internal software modules.

Typically, the internal software modules are assembled by a development team and installed on the collaborative data appliance. The collaborative data appliances can be located centrally, in direct contact with the user sources, or the collaborative data appliance can be located remotely, at a secure site. Furthermore, the number of internal software modules is determined by the users' needs, and the number of collaborative data appliances is governed by the number of users. The collaborative data appliance 100 is then externally modular to expand the capacity of the number of users the collaborative data appliance 100 can integrate. The collaborative data appliance expands by simply plugging another collaborative data appliance into the expansion port, essentially daisy-chaining the appliances together.

Furthermore, the collaborative data appliance 100 further comprises a discovery engine that formulates queries and submits formatted query statements to defined external data sources, an extraction engine that caches the discovered data into a temporary database on the collaborative data appliance 100 and arranges the data into customizable views based on the formulated queries, and a reporting engine that composes reports from the discovered data in the temporary database. The resulting reports can be directed to computer displays and/or printers.

The discovery engine utilizes Artificial Intelligence (AI) and User Input (UI). Specifically, the User Input for the discovery engine requires human input in regard to forming queries. However, once an initial query or queries is formulated for the discovery engine, subsequent queries can be dynamically generated from the results of previous queries down to four levels deep (currently, any number of levels as is known in the art are available) with keyed in, or alternatively input, intelligence on each search. The user would rate the results of each query, reporting back to the collaborative data appliance 100, and the rating information would then be used for future searches/queries, causing the future searches/queries to become ‘smarter’ or more refined over time.

Furthermore, the users can flag the data field by saving the search criteria, and the appliance records for a specific query (or queries). The saved search criteria is then used to prioritize data fields for future searches. A user flags a data field for further search operations by simply clicking on the label of each desired data field. A flag icon then appears next to each flagged data field's label. The flagging operation modifies a configuration file stored within the collaborative data appliance. The contents of this configuration file determine the outcome of subsequent search operations. A data field can be “unflagged” by simply clicking again on the data field label or the flag icon, after which the flag icon disappears from the data field label, and the aforementioned configuration file is modified accordingly.

Additionally, as described above, the collaborative data appliance 100 further comprises a discovery engine that submits formatted query statements to defined external data sources, an extraction engine that caches the discovered data into a temporary database on the collaborative data appliance 100, and a reporting engine that composes reports from the discovered data in the temporary database. The resulting reports can be directed to computer displays and/or printers.

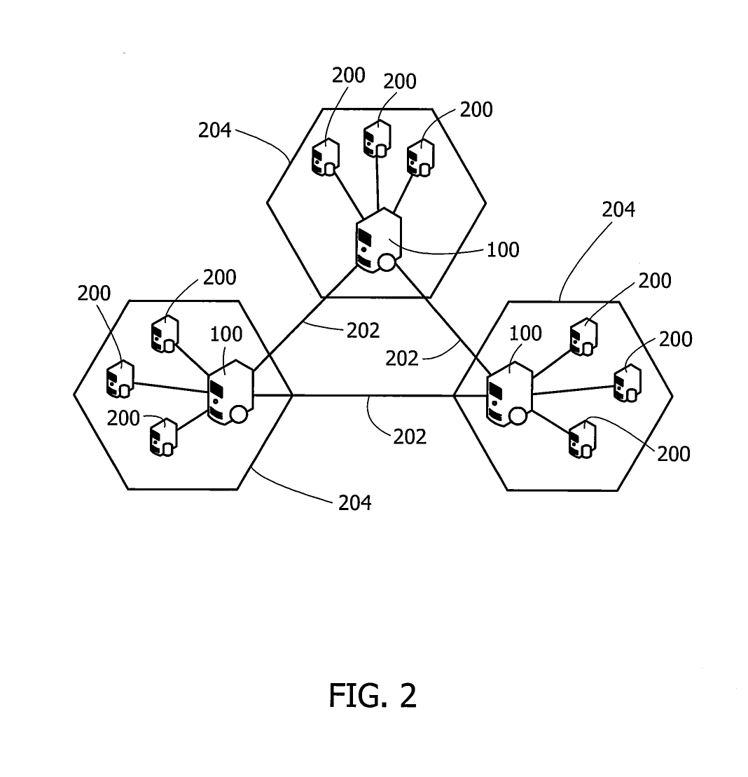

FIG. 2 illustrates multiple collaborative data appliances 100 providing database consolidation and systems integration in accordance with the disclosed architecture. The collaborative data appliance 100 comprises at least one internal software module designed to collect and combine data which is relevant to a user from disparate databases 200, and uniquely arranging the data into meaningful views which can be later customized into a multitude of data reports. Specifically, FIG. 2 shows three separate organizations 204, herein defined as business partners, government agencies, parent/subsidiaries, and/or branch offices, etc. Each organization 204 employs a collaborative data appliance 100, which collects data from a number of local data sources 200 at each organization 204. FIG. 2 further shows that each organization's collaborative data appliance 100 is connected to the collaborative data appliance 100 at each of the other organizations 204 via dedicated circuit and/or a virtual private network (VPN) connection 202. These connections permit each organization 204 to streamline the sharing of their own data with the other organizations.

Furthermore, with the collaborative data appliance's modular design, users will be able to quickly adapt to new data systems without any major modifications to their existing data infrastructure. And, the secure modular appliance-based design produces customizable data mining and displays for Enterprise Application Integration (EAI).

The collaborative data appliance 100 also allows a user to share information across user systems in a heterogeneous environment by replicating data between different hardware platforms and data sources, without losing the integrity of the data. The collaborative data appliance 100 essentially photographs the information within each database (or user source 200) then copies the data into a table, then the appliance flips the data into a temporary table, and then the discovery engine submits formatted query statements, the extraction engine caches the discovered data and begins the organization process, and the reporting engine uniquely arranges the data into meaningful views which can be later customized into a multitude of data reports.

Internal software modules are then assembled by a Development Team and installed on the collaborative data appliance 100. The collaborative data appliance 100 retains the internal software modules, and externally, the collaborative data appliance 100 also features a military-graded encryption code. The encryption code is used to secure the information contained within the internal software modules. Typically, the encryption utilized is in compliance with Federal Information Processing Standard (FIPS). Specifically, encryption standards such as Data Encryption Standard (FIPS 46-3) and the Advanced Encryption Standard (FIPS 197) are used.

The collaborative data appliance 100 is then externally modular to expand the capacity of the number of users the collaborative data appliance 100 can integrate by connecting to other collaborative data appliances 100 through a virtual private network (VPN) 202 or other dedicated circuit as is known in the art. For example, a user would log onto the appliance 100 by way of a user interface, and then connect to another appliance via a VPN. Connection to another appliance allows access to additional user sources 200 which are outside the security of the first appliance. Specifically, the collaborative data appliance 100 is securely collecting information from data sources 200 based upon a user's request. The data sources 200 could be located on and/or off-site. Additionally, users could log onto the appliance 100 via a secure website instead of the VPN. Utilizing a user interface, users would enter a secure website and log onto a specific appliance 100.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

For the purposes of this application, the methodology with which the appliance mines, caches, (i.e., “photographs”) the data, then constructs a “table” at the core software level, then flips the data within the device, then “shows” the data in a single web-based user interface is accomplished without needing to permanently warehouse the mined and/or cached data.

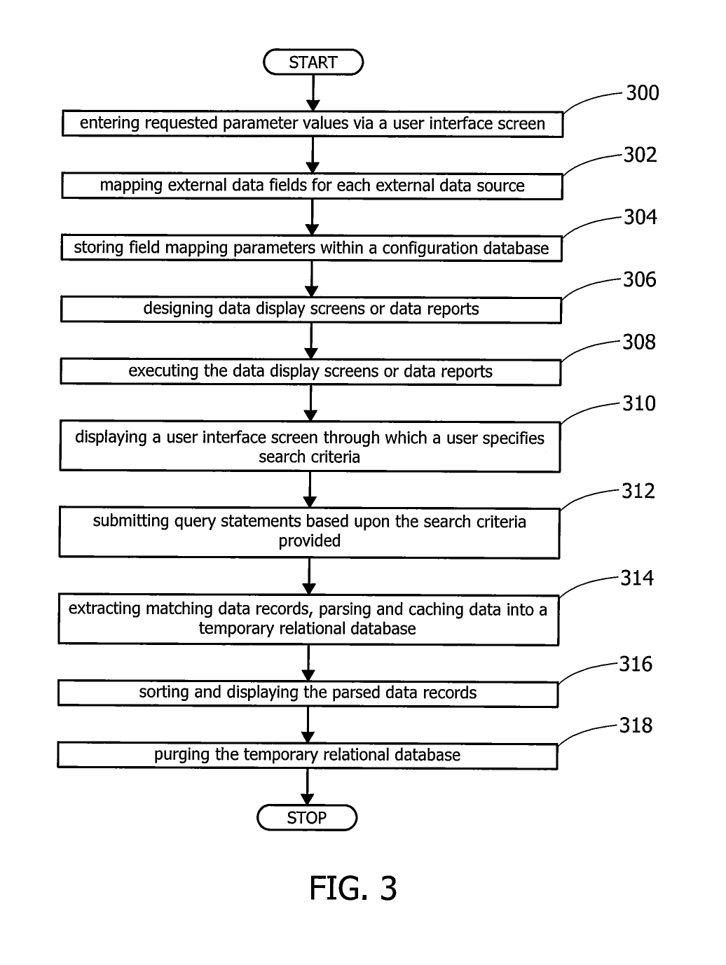

Specifically, FIG. 3 illustrates a method for database consolidation and systems integration. At 300, parameters for connection to external data sources are prompted by a user interface screen displayed by the collaborative data appliance, and users enter the requested parameter values by way of this user interface screen. These parameters are stored within a configuration database internal to the collaborative data appliance. This process need not be repeated for external data sources that have previously been defined in this way on the collaborative data appliance.

At 302, for each external data source, external data fields are mapped to data fields defined within the collaborative data appliance. This can occur in two ways: automatic field mapping or manual field mapping. Automatic field mapping: The “schema,” or database structure, of the external database is discovered by a software process executed by the collaborative data appliance. Data fields within the external data source are mapped to data fields defined within the collaborative data appliance. Manual field mapping: Using a user interface screen displayed by the collaborative data appliance, users specify data fields to be selected from the external data source, and to which data field within the collaborative data appliance each selected external data field should correspond. At 304, field mapping parameters, whether automatic or manual, are stored within a configuration database internal to the collaborative data appliance. Processes 302 and 304 need not be repeated for external data fields that have previously been mapped in this way on the collaborative data appliance.

At 306, a user using a user interface screen displayed by the collaborative data appliance designs data display screens and/or data reports. During this process, each screen or report is named and data fields internal to the collaborative data appliance (which were previously mapped to data fields within external data sources) are selected and arranged by the user as desired. Furthermore, parameters for the selection and arrangement of data fields can be stored within a configuration database internal to the collaborative data appliance. This process need not be repeated for data display screens and/or data reports that have previously been defined in this way on the collaborative data appliance.

At 308, using a user interface screen displayed by the collaborative data appliance, users select a data display screen or data report to execute. At 310, based upon the data display screen or data report selected, the collaborative data appliance displays a user interface screen, through which the user specifies search criteria for one or more related data fields. And at 312, based upon the data display screen or data report selected and the search criteria provided by the user, the collaborative data appliance's data discovery function submits properly formatted query statements to the corresponding external data source(s). At 314, the collaborative data appliance's data extraction function extracts matching data records, parsing and caching their contents into a temporary relational database within the collaborative data appliance.

At 316, the collaborative data appliance's reporting function then sorts and displays or prints the parsed data records as designed by the user in the previous steps. And at 318, once the user has closed the selected data display screen or data report, all data that was discovered and extracted for that data display screen or data report is purged from the temporary relational database within the collaborative data appliance. This helps to keep the external data secure, and to ensure that fresh data will be presented for the next data display screen and/or data report execution.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

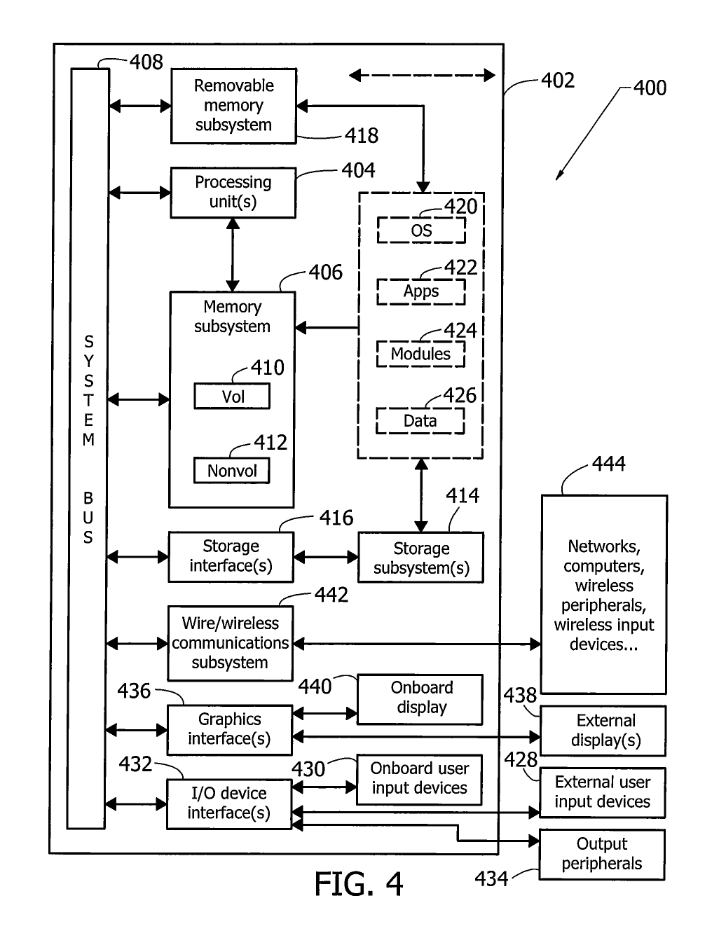

Referring now to FIG. 4, there is illustrated a block diagram of a computing system 400 operable to execute the software framework in accordance with the disclosed architecture. In order to provide additional context for various aspects thereof, FIG. 4 and the following discussion are intended to provide a brief, general description of the suitable computing system 400 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 400 for implementing various aspects includes the computer 402 having processing unit(s) 404, a system memory 406, and a system bus 408. The processing unit(s) 404 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 406 can include volatile (VOL) memory 410 (e.g., random access memory (RAM)) and non-volatile memory (NON-VOL) 412 (e.g., ROM, EPROM, EEPROM, etc.). A basic input/output system (BIOS) can be stored in the non-volatile memory 412, and includes the basic routines that facilitate the communication of data and signals between components within the computer 402, such as during startup. The volatile memory 410 can also include a high-speed RAM such as static RAM for caching data.

The system bus 408 provides an interface for system components including, but not limited to, the memory subsystem 406 to the processing unit(s) 404. The system bus 408 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 402 further includes storage subsystem(s) 414 and storage interface(s) 416 for interfacing the storage subsystem(s) 414 to the system bus 408 and other desired computer components. The storage subsystem(s) 414 can include one or more of a hard disk drive (HDD), a magnetic floppy disk drive (FDD), and/or optical disk storage drive (e.g., a CD-ROM drive DVD drive), for example. The storage interface(s) 416 can include interface technologies such as EIDE, ATA, SATA, and IEEE 1384, for example.

One or more programs and data can be stored in the memory subsystem 406, a removable memory subsystem 418 (e.g., flash drive form factor technology), and/or the storage subsystem(s) 414 (e.g., optical, magnetic, solid state), including an operating system 420, one or more application programs 422, other program modules 424, and program data 426.

The aforementioned application programs 422, program modules 424, and program data 426 can include the collaborative data appliance 100 of FIG. 1, including the internal software modules and discovery engine, and the entities and components and arrangement of the appliance in FIG. 2. The aforementioned application programs 422, program modules 424, and program data 426 can also include the methods represented by the flow chart of FIG. 3, for example.

Generally, programs include routines, methods, data structures, other software components, etc., that perform particular tasks or implement particular abstract data types. All or portions of the operating system 420, applications 422, modules 424, and/or data 426 can also be cached in memory such as the volatile memory 410, for example. It is to be appreciated that the disclosed architecture can be implemented with various commercially available operating systems or combinations of operating systems (e.g., as virtual machines).

The storage subsystem(s) 414 and memory subsystems (406 and 418) serve as computer readable media for volatile and non-volatile storage of data, data structures, computer-executable instructions, and so forth. Computer readable media can be any available media that can be accessed by the computer 402 and includes volatile and non-volatile media, removable and non-removable media. For the computer 402, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 402, programs, and data using external user input devices 428 such as a keyboard and a mouse. Other external user input devices 428 can include a microphone, an IR (infrared) remote control, a joystick, a game pad, camera recognition systems, a stylus pen, touch screen, gesture systems (e.g., eye movement, head movement, etc.), and/or the like. The user can interact with the computer 402, programs, and data using onboard user input devices 430 such a touchpad, microphone, keyboard, etc., where the computer 402 is a portable computer, for example. These and other input devices are connected to the processing unit(s) 404 through input/output (I/O) device interface(s) 432 via the system bus 408, but can be connected by other interfaces such as a parallel port, IEEE 1384 serial port, a game port, a USB port, an IR interface, etc. The I/O device interface(s) 432 also facilitate the use of output peripherals 434 such as printers, audio devices, camera devices, and so on, such as a sound card and/or onboard audio processing capability.

One or more graphics interface(s) 436 (also commonly referred to as a graphics processing unit (GPU)) provide graphics and video signals between the computer 402 and external display(s) 438 (e.g., LCD, plasma) and/or onboard displays 440 (e.g., for portable computer). The graphics interface(s) 436 can also be manufactured as part of the computer system board.

The computer 402 can operate in a networked environment (e.g., IP) using logical connections via a wired/wireless communications subsystem 442 to one or more networks and/or other computers. The other computers can include workstations, servers, routers, personal computers, microprocessor-based entertainment appliance, a peer device or other common network node, and typically include many or all of the elements described relative to the computer 402. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet. Further, the software framework system can operate over the Internet in an Application Service Provider (ASP) environment, wherein the system is hosted at a data center and a user logs-in via a secure connection over the Internet.

When used in a networking environment the computer 402 connects to the network via a wired/wireless communication subsystem 442 (e.g., a network interface adapter, onboard transceiver subsystem, etc.) to communicate with wired/wireless networks, wired/wireless printers, wired/wireless input devices 444, and so on. The computer 402 can include a modem or has other means for establishing communications over the network. In a networked environment, programs and data relative to the computer 402 can be stored in the remote memory/storage device, as is associated with a distributed system. It will be appreciated that the network connections shown are exemplary and other means of establishing a communications link between the computers can be used.

The computer 402 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

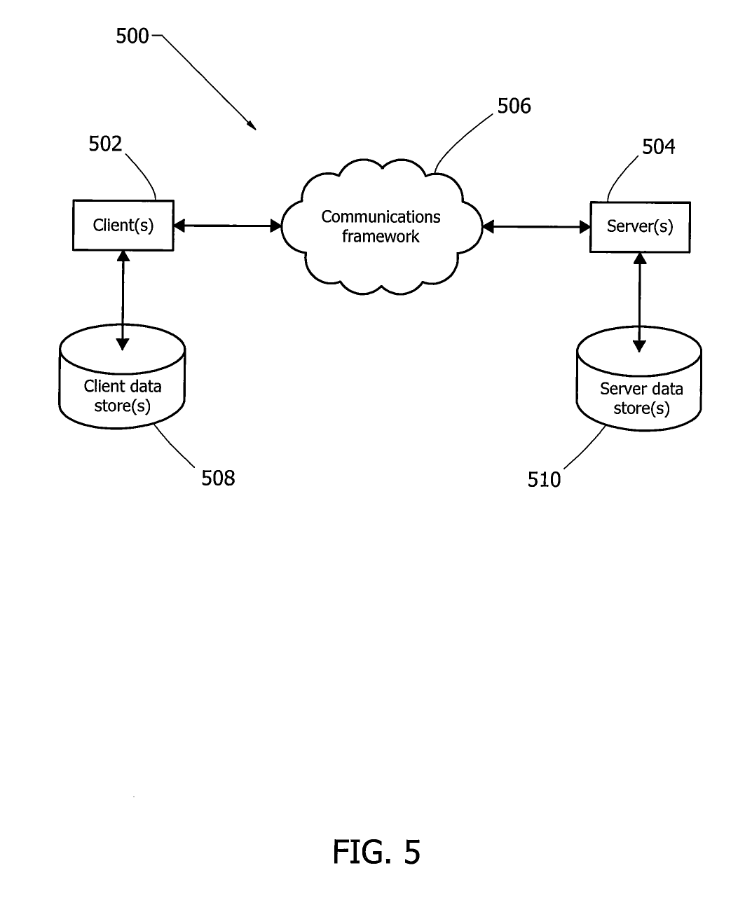

Referring now to FIG. 5, there is illustrated a schematic block diagram of a computing environment 500 operable to provide support for the software framework. The environment 500 includes one or more client(s) 502. The client(s) 502 can be hardware and/or software (e.g., threads, processes, computing devices). The client(s) 502 can house cookie(s) and/or associated contextual information, for example.

The environment 500 also includes one or more server(s) 504. The server(s) 504 can also be hardware and/or software (e.g., threads, processes, computing devices). The servers 504 can house threads to perform transformations by employing the architecture, for example. One possible communication between a client 502 and a server 504 can be in the form of a data packet adapted to be transmitted between two or more computer processes. The data packet may include a cookie and/or associated contextual information, for example. The environment 500 includes a communication framework 506 (e.g., a global communication network such as the Internet) that can be employed to facilitate communications between the client(s) 502 and the server(s) 504.

Communications can be facilitated via a wire (including optical fiber) and/or wireless technology. The client(s) 502 are operatively connected to one or more client data store(s) 508 that can be employed to store information local to the client(s) 502 (e.g., cookie(s) and/or associated contextual information). Similarly, the server(s) 504 are operatively connected to one or more server data store(s) 510 that can be employed to store information local to the servers 504.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A collaborative data appliance for database consolidation and systems integration, comprising:
a computer processing system enabled to consolidate and integrate databases;
at least one internal software module that collects and combines data from the databases and is operatively coupled to the computer processing system; and
a discovery component coupled to the at least one internal software module that formulates queries and arranges the data into customizable views based on the formulated queries.

2. The collaborative data appliance of claim 1, wherein the at least one internal software module are at least one of clusterable, flexible, or expandable.

3. The collaborative data appliance of claim 1, further comprising an extraction component that caches the data into a temporary database on the collaborative data appliance.

4. The collaborative data appliance of claim 3, further comprising a reporting component that composes reports from the data in the temporary database and directs the reports to a computer display or printer.

5. The collaborative data appliance of claim 1, wherein the discovery component utilizes artificial intelligence (AI) and user input (UI) to formulate the queries.

6. The collaborative data appliance of claim 5, wherein users rate results of the queries, and rating information would then be reported back to collaborative data appliance and used for future queries.

7. The collaborative data appliance of claim 6, wherein the queries are generated down to four levels deep.

8. The collaborative data appliance of claim 1, wherein number of modules is determined by a user's needs and number of collaborative data appliances is determined by a number of users.

9. A collaborative data appliance for database consolidation and systems integration, comprising:
a computer processing system enabled to consolidate and integrate databases;
at least one internal software module that collects and combines data from the databases and is operatively coupled to the computer processing system;
a discovery component coupled to at least one internal software module that formulates queries and arranges the data into customizable views based on the formulated queries; and
an extraction component coupled to at least one internal software module that caches the data into a temporary database on the collaborative data appliance.

10. The collaborative data appliance of claim 9, wherein number of modules is determined by a user's needs and number of collaborative data appliances is determined by a number of users.

11. The collaborative data appliance of claim 9, wherein the collaborative data appliance is located centrally, in direct contact with a data source.

12. The collaborative data appliance of claim 9, wherein the collaborative data appliance is located remotely, at a secure site.

13. The collaborative data appliance of claim 9, wherein the discovery component utilizes artificial intelligence (AI) and user input (UI) to formulate the queries.

14. The collaborative data appliance of claim 9, further comprising a reporting component that composes reports from the data in the temporary database and directs the reports to a computer display or printer.

15. A computer-implemented method for database consolidation and systems integration, using a processor coupled to memory, comprising:
entering requested parameter values via a user interface screen;
mapping external data fields for each external data source;
storing field mapping parameters within a configuration database;
designing data display screens or data reports; and
executing the data display screens or data reports.

16. The method of claim 15, further comprising displaying a user interface screen through which a user specifies search criteria.

17. The method of claim 16, further comprising submitting query statements based upon the search criteria provided.

18. The method of claim 17, further comprising extracting matching data records, parsing and caching data into a temporary relational database.

19. The method of claim 18, further comprising sorting and displaying the parsed data records.

20. The method of claim 19, further comprising purging the temporary relational database.
